(19) United States
(12) Patent Application Publication
(10) Pub. No.: US 2018/0216042 A1
(43) Pub. Date: Aug. 2, 2018

(54) HEAVY-DUTY LAUNDRY DETERGENT WIPE WITH WASHING ACTIVE SUBSTRATE

(71) Applicant: COIN CONSULTING GMBH, Menden (DE)

(72) Inventors: Marcus MAUSBERG, Menden (DE); Michael PULINA, Krefeld (DE); Jost ADLER, Muelheim (DE)

(73) Assignee: COIN Consulting GmbH, Menden (DE)

(21) Appl. No.: 15/506,112

(22) PCT Filed: Aug. 20, 2015
(86) PCT No.: PCT/DE2015/000416

§ 371 Date: Feb. 23, 2017

(30) Foreign Application Priority Data
Aug. 25, 2014 (DE) 10 2014 012 380.4

(51) Int. Cl. C11D 3/42; C11D 17/04; C11D 3/12; C11D 11/00; C11D 1/02

(52) U.S. Cl. CPC C11D 3/42; C11D 17/041; C11D 1/02; C11D 3/128; C11D 11/0017; C11D 3/1253

(57) ABSTRACT

The present invention discloses a homogeneous three-phase laundry detergent wipe and a method for manufacturing same, wherein washing active substances which are water insoluble and solid at ambient temperature are incorporated into a substrate which is solid at ambient temperature such that the substances are homogeneously distributed across the substrate after incorporation, and wherein the substrate so functionalized is impregnated with an impregnating liquid. The substances incorporated into the wipe can be zeolites and/or phyllosilicates and/or optical brighteners.

### FIELD OF THE INVENTION

The present invention is directed to heavy-duty laundry detergent wipes for cleaning textiles and, in particular, to heavy-duty laundry detergent wipes, wherein the substrate comprises homogeneously distributed washing active components, and to a method for manufacturing same.

### BACKGROUND OF THE INVENTION AND PRIOR ART

The pursuit of hygiene exists from the beginning of mankind. Hygiene eventually is an important aspect of everyday life. The hygienic approach primarily consists in maintaining the health. In addition to the general cleaning effects scent and improved cleaning power of the raw material compositions have also come under scrutiny due to extended possibilities. Cleaning power optimization is particularly characterized by the ability to extend a hygienically clean state and an improvement of the degree of cleaning.

Nowadays hygiene can be divided into the fields of body, surface and textile hygiene. The latter is divided into applications depending on textile material and color. At least since the Nineties of the 20^{th} century the consumer's awareness has been raised of ecological cleaning. In this regard, it is desirable to maintain the advantages of conventional washing detergents, on the one hand, and to find further innovative and ecologically feasible product solutions, on the other hand.

With the beginning of industrial production, laundry detergents have been realized as powders. This very day, a powder laundry detergent consists of a mixture of different washing active substances.

With the progress during the development of laundry detergents enzymes and other new surfactant compounds entered this market segment. In addition to the substances necessary for cleaning large amounts of filler material are added nowadays. Accordingly, no change of the consumer's dosing behavior was necessary. First attempts to omit filler material resulted in an overdosing of the surfactants due to the application the users were used to.

Then liquid washing detergents were introduced which could be dosed residue-free and, thus, offered a physical alternative to the mixture of solids of laundry detergents. However, up to now liquid washing detergents do not accomplish the cleaning level of a heavy-duty laundry detergent (i.e., a mixture of solids). This is due to the fact that a liquid washing detergent is limited to liquid components or components which are well soluble in water. The essential substances missing in a liquid washing detergent are the zeolites. The latter support dirt adsorption and brightening/color fastness during the application.

A current product trend is the simplified way of portioning the washing detergent. This can be achieved, on the one hand, by packing a liquid washing detergent in small polymer pouches. Another physical modification of the washing detergent consists in mixing a washing detergent with a fatty alcohol in order to achieve desired forms. DE 10 2010 060 126 A1 discloses a two-phase product in the form of a laundry detergent wipe, characterized by the combination of a hydrophilic carrier material and an impregnating liquid.

In contrast thereto, DE 10 2013 014 015 discloses a three-phase product, wherein a dispersion is applied to a substrate which is solid at ambient temperature. Due to the use of a dispersion for the first time, a cleaning power with the features of a powdered washing detergent (zeolites, phyllosilicates) could be achieved. Primarily hydrophobic carrier substrates have been used because the laundry detergent dispersion also has hydrophilic characteristics due to the higher amount of washing active substances as compared to the two-phase system. DE 10 2014 004 915 discloses a further improved three-phase product with a more homogeneous distribution of the washing active substances and a method for manufacturing same.

Accordingly, it is the object of the present invention to provide a laundry detergent wipe with a homogeneous distribution of the washing active substances and the solid components of the dispersion, resp., on the substrate in order to achieve a further improved distribution of the active substances and, thus, a better performance of the laundry detergent wipe.

### SUMMARY OF THE INVENTION

It is an object of the present invention to provide a three-phase laundry detergent wipe which shows a more even, in particular, homogeneous, distribution of the washing active substances and the solid components of the dispersion, resp., on the substrate. It is another object of the present invention to provide a method for manufacturing same.

This object has been achieved by a method for manufacturing a homogeneous three-phase laundry detergent wipe according to claim 1, which is characterized by the following steps: (a) incorporating washing active substances which are water insoluble and solid at ambient temperature into a substrate which is solid at ambient temperature such that the substances are homogeneously distributed over the substrate after incorporation, (b) impregnating the substrate so functionalized with an impregnating liquid.

This object has also been achieved by a three-phase laundry detergent wipe according to claim 6, comprising a substrate which is solid at ambient temperature and impregnated with an impregnating liquid, characterized in that washing active substances which are water insoluble and solid at ambient temperature have been incorporated into the substrate such that the substances are homogeneously distributed over the substrate.

Advantageous embodiments of the inventive three-phase laundry detergent wipe and its manufacturing method are disclosed in the dependent claims.

### DESCRIPTION OF THE PREFERRED EMBODIMENTS

Generally, the distribution of the washing active substances and the solid components of the dispersion, resp., on a substrate is not homogeneous. The inventive three-phase laundry detergent wipe with homogeneous distribution of the washing active substances and the solid components, resp., could be realized by incorporating the secondary builders (zeolite and/or phyllosilicates and/or optical brighteners), which so far have been components of the dispersion applied to the substrate, in the substrate which is solid at ambient temperature during its manufacturing process—i.e., before applying an impregnating liquid. The solid water insoluble additives can be added by means of a water bath before solidification of the substrate. Alternatively, the zeolite and/or the phyllosilicates can be sprayed onto the substrate during its manufacturing via a suspended dispersion (e.g., additive/water).

Incorporating solid water insoluble and washing active substances (here: zeolite and/or phyllosilicates and/or optical brighteners) results in an activation of the substrate with components which provide the three-phase final product with the features of a heavy duty laundry detergent. After incorporating the solids the substrate so functionalized is impregnated with an impregnating liquid which is a liquid washing detergent. Impregnation of the functionalized substrate can be obtained by immersion in an immersion bath, spraying the liquid washing detergent onto the activated substrate or moistening the substrate with the liquid washing detergent using one or more moistening rods.

The method of incorporating water insoluble solids into the substrate before applying the impregnating liquid has the following advantages:
a) applicability of larger particles
b) distribution of the washing active and water insoluble solids across the entire substrate depth (homogeneous distribution)
c) depot function of the functional solids incorporated into the substrate resulting in a longer lasting diffusion of the particles during the washing process such that they are available over a longer period of time.

Non-wovens from filament fibers (continuous filaments), in particular, from the following materials are suitable for the substrate:
polypropylene
polyethylene
viscose
polyester
polyamide
and mixtures of these raw materials

The above mentioned raw materials for the substrate can be fiber mixtures (of one or more filament fibers) as well as joint fibers (jacket-core or side by side). The components described above are hydrophobic and thus have the advantageous feature to adsorb hydrophobic textile colors in the hydrophilic washing water.

The present invention can be used in all categories of laundry detergents. For example, the following laundry detergent solutions were used:

Heavy duty laundry detergent wipe (universal):

anionic tensides
nonionic tensides
phosphonates/complex builders
C10-C18 fatty acid salts
optical brighteners
enzymes
stabilizers (propylene glycol, glycerine, borax, inulin)
scents
preservatives
soil-release polymer
pH regulators

Color laundry detergent wipe (color):

anionic tensides
nonionic tensides
phosphonates/complex builders
C10-C18 fatty acid salts
colorants
color transfer protectors
hydrotropes (sodium cumenesulfonate)
enzymes
stabilizers (propylene glycol, glycerine, borax, inulin)
scents
preservatives
soil-release polymer
pH regulators

Black laundry detergent wipe (black):

anionic tensides
nonionic tensides
phosphonates/complex builders
C10-C18 fatty acid salts
colorants
color transfer protectors
enzymes
stabilizers (propylene glycol, glycerine, borax, inulin)
opacifiers
scents
preservatives
pH regulators

White laundry detergent wipe (white):

anionic tensides
nonionic tensides
C10-C18 fatty acid salts
optical brighteners
soil-release polymer
color transfer protectors
enzymes
stabilizers (propylene glycol, glycerine, borax, inulin)
colorants
opacifiers
scents
preservatives
pH regulators

Fine laundry detergent wipe:

anionic tensides
nonionic tensides
C10-C18 fatty acid salts
phosphonates/complex builders
color transfer protectors
enzymes
stabilizers (propylene glycol, glycerine, borax, inulin)
scents
defoamers
preservatives
pH regulators

Wool laundry detergent wipe:

anionic tensides
nonionic tensides
amphoteric tensides
C10-C18 fatty acid salts
phosphonates/complex builders
color transfer protectors
scents
preservatives
opacifiers
conditioners
pH regulators

The liquid washing detergent of the impregnating liquid can have a viscosity greater than 500 mPas. Furthermore, all known components of a heavy-duty laundry detergent can be included.

1.-10. (canceled)

11. A method for the manufacturing of a homogeneous three-phase laundry detergent wipe, having the following steps:
(a) providing washing active substances which are water insoluble and solid at ambient temperature;
(b) providing a substrate which is solid at ambient temperature;
(c) incorporating said washing active substances into said substrate such that the substances are homogeneously distributed over the substrate after incorporation,
(d) impregnating the substrate so functionalized with an impregnating liquid.

12. The method of claim 11, wherein the washing active water insoluble substances comprise zeolites and/or phyllosilicates and/or optical brighteners.

13. The method of claim 11, wherein the substrate is consisting of at least one continuous filament or a joint fiber.

14. The method of claim 11, wherein the substrate is consisting of at least one hydrophobic synthetic fiber such that it provides color adsorption.

15. The method of claim 11, wherein the impregnating liquid is a liquid washing detergent.

16. A three-phase heavy-duty laundry detergent wipe, comprising
(a) a substrate which is solid at ambient temperature and impregnated with an impregnating liquid, and
(b) washing active substances which are insoluble in water and solid at ambient temperature, wherein
(c) said substances have been incorporated into the substrate such that the substances are homogeneously distributed over the substrate.

17. The three-phase heavy-duty laundry detergent wipe of claim 16, wherein the washing active water insoluble substances comprise zeolites and/or phyllosilicates and/or optical brighteners.

18. The three-phase heavy-duty laundry detergent wipe of claim 16, wherein the substrate is consisting of at least one continuous filament or a joint fiber.

19. The three-phase heavy-duty laundry detergent wipe of claim 16, wherein the substrate is consisting of at least one hydrophobic synthetic fiber such that it provides color adsorption.

20. The three-phase heavy-duty laundry detergent wipe of claim 16, wherein the impregnating liquid is a liquid washing detergent.
